(19) United States
(12) Patent Application Publication
(10) Pub. No.: US 2002/0052765 A1
(43) Pub. Date: May 2, 2002

(54) Method and apparatus for insuring multiple unit dwellings

(76) Inventor: Don Taylor, Salt Lake, UT (US)

Correspondence Address: MARCUS G THEODORE, PC, 466 SOUTH 500 EAST, SALT LAKE CITY, UT, 84102, US

(21) Appl. No.: 09/921,251

(22) Filed: Aug. 3, 2001

Related U.S. Application Data
(63) Continuation-in-part of application No. 09/476,559, filed on Jan. 3, 2000.

(51) Int. Cl. G06F 17/60

(52) U.S. Cl. 705/4

(57) ABSTRACT

A method and apparatus for insuring both the owner and tenants within an apartment or multi-unit dwelling comprising: inputting into a computer processor a data base of building physical information, occupancy information, and tenant rental information; inputting into the computer processor an insurance qualification program for tenant insurance covering both the building owner and tenant from unintentional damage caused by the tenant from fire, smoke, explosions, water damage, or negligence injuries by the tenant caused to third parties pursuant to predetermined insurability criteria; qualifying the building for tenant and owner occupancy insurance, and computer translating and generating insurance coverage for the building owner based on the number of units in the building and insurance coverage limits desired, and billing the owner for renter's single interest insurance.

### RELATED APPLICATIONS

This application is a continuation-in-part of the original filed application entitled “Method and Apparatus for Insuring Multiple Unit Dwellings”, Ser. No. 09/476,559 filed Jan. 03, 2000.

### BACKGROUND OF THE INVENTION

1. Field

This invention relates to methods for insuring owners of and tenants occupying multiple unit dwellings and buildings. More particularly, it relates to a method and apparatus to insure the owner and tenants within apartments or multi-unit dwellings from accidental losses caused by the tenant.

2. State of the Art

Joint insurance coverage for owners of and tenants occupying multiple dwelling units in a building is currently not possible to write, because it is cost prohibitive to issue a large number of small policies covering individual units. Further, many lease clauses require renter's insurance coverage. However, approximately 90% of the 35 million apartment units in the United States are currently uninsured. Landlords currently do not have a process to verify or enforce the lease requirements of mandatory insurance. This places an enormous burden on the insurance agent to try and maintain adequate insurance coverage for the building owner. There is currently no insurance liability trail back to the tenant. Nor is there a product or method currently available to mass insure all tenants of an apartment building or multiple unit dwelling complexes. Renters insurance, unlike homeowners insurance, which normally has a third party, the mortgagee, as the enforcer, has currently no means of enforcement. This being the case, present insurance methods do not allow insurance companies to apply the principles of large numbers. The principle of large number provides for the spread of risk over members of a similar pool, allowing insurance companies to actuarially lower costs, increase profits and improve service.

The method and apparatus described below provides insurance coverage to protect both the landlord and tenant from negligent acts by the tenant that affect the building owner and unintentional tenant acts causing fire, smoke, explosion and water damage to the building unit. Present economic feasibility is non-existent from sales sources, the agent, to provider, the insurance company. The mass insuring method, built in rate computation, and innovative delivery system of this invention will provide the solution to economic feasibility for all.

### SUMMARY OF THE INVENTION

The invention comprises a method and apparatus to gather, prepare, and maintain sufficient tenant insurance data to enable insurance coverage to be written to cover both the tenant and the building owner from unintentional tenant acts causing fire, smoke, explosion, and water damage. Renter's single interest (RSI) coverage, such as that provided by applicant under the servicemark “Rentors Single Interest™”, covers the building owner from unintentional damage caused by the tenant from fire, smoke, explosions, water damage, or negligence injuries caused by the tenant to third parties pursuant to predetermined insurability criteria. Based on the RSI building coverage, the tenant may apply for tenant occupancy insurance (TOI). This coverage would be similar to a present renters homeowners policy. Coverage would include tenant property, liability to a third party and damage to the apartment building pursuant to predetermined insurability criteria. As TOI insurance is an add-on to the RSI building, it may be written at a group rate, thereby allowing the tenant a more affordable rate than heretofore available. The reason is because TOI insurance pricing is based on larger numbers of the entire building complex rather than the traditional underwriting for only one specific unit. This results in a larger insurance coverage pool lowering costs to issue, administer and cover any losses incurred in the building complex. The exact premium for TOI insurance coverage is also dependent upon the limits of coverage for personal property specified by the tenant. By limiting the extent of coverage, TOI insurance pricing is not open ended; thereby further reducing the premium charged. In addition, the premium rates for RSI coverage on the building owner may be reduced, depending upon the percentage of units in the building, which are additionally covered by TOI insurance. The method therefore takes advantage of the law of large numbers providing universal, capped, add on insurance coverage to the occupants of entire building at a very low cost.

The first step of the method is to input into a large computer data base sufficient insurance information concerning each apartment or multi-unit dwelling complex within a geographical area.

### Data Bases

The data bases inputted into the computer processor are:

a. “Building Physical Information” about the apartment complex or multi-unit dwelling complex from all owners and business managers seeking insurance coverage within a geographical area. This information is inputted monthly, and contains the full name of the insured, the mailing addresses of the units, the number of buildings, the fire insurance policy on the building and building rating by the four basic types of construction recognized in fire insurance coverage-i.e. a Class A building is one with walls, floors, and roof of masonry or concrete, and with all load walls supported by an independent steel frame. A Class B structure is similar to Class A except that interior walls and floors are not constructed of masonry or concrete. A Class C building does not meet all specific requirements of Class B. A Class D building generally refers to frame structures and includes most private residences.

b. “Occupancy Information” about the apartment complex or multi-unit dwelling complex from all owners and business managers seeking insurance coverage within a geographical area specifying the total number of units occupied, and the total number of units vacant at the last reporting period.

c. “Tenant Rental Information” from all owners and business managers and tenants within a geographical area seeking insurance coverage containing the lease agreement requirements, a credit report on the tenant coded to meet legal confidentiality requirements, a criminal background check of the tenant, and a character reference check of the tenant to verify his past tenant conduct.

The above data is preferably received on-line via the internet, or in a variety of media types, including tapes, cartridges, discs, etc. and is integrated with a data integration system to include all relevant data, even though this initially generates redundant entries. Once the fire insurance data is entered, it generally doesn't change unless the building is remodeled or the building is damaged.

The other information varies continuously, and has to be periodically updated and inputted to reflect the current rental status and renter identity of each unit. The renter's single interest coverage (RSI) begins on the date of occupancy, and ends as of the date the tenant leaves. Continuous monitoring insures that empty units are not covered, and that the current tenant is covered as an insured. This lowers the overall cost of insurance to the owner by avoiding payment for non-existent insurance coverage on empty units. For example, monthly entries are inputted by each property manager or building owner via a combined internet screen with drop down sub-screens, or up to four screens gathering the necessary information for transmittal through the internet. This information is thus preferably reported on standardized combined or separate interactive computer screens. The first standardized screen, or drop down sub-screen, is the Renter's Single Interest Screen, which will list all of the tenants in the apartment complex. The second standardized screen, or drop down sub-screen, is the Tenant Occupancy Insurance Screen, which lists the tenants that have purchase insurance through the apartment complex over the basic renter's single interest (RSI) coverage. The third standardized screen, or drop-down sub-screen, is the Certificate Screen, which lists the tenants that have provided their own insurance through other means. The fourth standardized screen, or drop-down sub-screen, is the Vacancy screen, which lists those units not currently occupied. These computer screens are interactive and can be added to or deleted from at the end of every month or reporting period.

Thus, an entry is made for every tenant in the apartment by unit, even though a tenant may occupy several different units. This may result in multiple entries for each tenant, but insures that there is at least one entry per occupied unit. Because the raw data is inputted in a variety of formats, there is no need for extensive personnel training time as to the proper data fields and procedures. The system can, therefore, be operated by property leasing personnel utilizing computers to update the system. The employment of these property leasing personnel as an arm of the insurance sales force provides participation by persons more sensitive to the needs of their residents, communities, and homes. Thus, insensitive technically correct insurance sales jargon employing such as the terms “renter”, “tenant”, “apartment”, “tenement”, and “complex” is avoided in favor of managers protecting residents' homes. These property leasing personnel are also more familiar with the needs and vocabulary of the multi-unit housing industry, and therefore provide more meaningful and effective RSI and TOI product sales.

They should also be able to qualify for limited insurance licenses as RSI coverage is limited to coverage of property damage liability concerning only unintentional damage caused by fire, smoke, explosion and water damage.

The tenant's rent payment includes the renters single interest insurance coverage acquired by the landlord. The computer automatically adds to the monthly rent bills a surcharge for the added insurance coverage. Thus, the computer program prepares bills via a data sort from the compiled screens. Funds due can then be transferred on line via electronic funds transfers (EFT), Credit Cards, etc.

Other tenants may elect to provide a certificate of their own standard renter's insurance, which also covers their personal property in addition to damage to the unit. A traditional insurance certificate, which names the property owner as an additional insured and/or certificate holder of record is employed for this purpose. This information is then entered into the computer data base to enable a building manager or owner to monitor the insurance status of the unit. Alternatively, tracking self certifying residents can be done by a remote central monitoring group interconnected to access of the system to alleviate the burden on the property owner. The insurance product thus has an endorsement naming the landlord as a certificate holder of record on any policy certificate. This means that in case the policy is cancelled by a tenant, the landlord will have 10 days pre-notification. The building owner would then electronically arrange for RSI coverage and the tenant billed via the system to insure 100% lease compliance. It is contemplated that insurance company credits to the policies covering the property owner's package insurance policy will be available where there is 100% lease compliance. 100% compliance may also make the property owner eligible for a preferred tier rating by participating companies. These participating companies offering credits for 100% lease compliance will be issued RSI certificates. RSI certified companies can advertise on-line on interactive web sites connected to the system where residents can purchase self generated TOI policies. Optional HO-4 form policies may also be offered on-line to residents as property liability for qualifying multi-unit complexes has already been purchased by the property owner in the form of RSI. Insurance companies offering traditional HO-4 form policies may also be linked to advertise on the website of participating companies under mutually agreeable terms.

Those ordering the HO-4 policies on-line under the present system may also be able to pay for this insurance as part of the lease payment. The system also enables property owners to charge a billing fee covering administrative expenses in addition to the premium for RSI coverage to provide an additional source of revenue for the building owner.

Tenants wishing to purchase their own tenant occupancy insurance based on the renter's single interest insurance policy can also do so via the internet, once the building has been qualified for renter's single interest insurance coverage.

The apparatus employs a computer processor to cross-index and sort the databases to insure that all tenants, owners, and insurance coverages are properly matched. In addition, the data base inputs go through a testing process to check for errors and variances from previously submitted data. The identity of incomplete data is then summarized into missing information reports, which are sent to the submitting owner or business manager. These incomplete information reports may also be sent to the agent for the insurance carrier covering the apartment or multi-unit dwelling complex advising the insurance of the incomplete data forms and requesting the missing information.

### Methodology

The second step of the method is comprised of first compiling, inputting and expanding the data base of tenant insurance information into a computer processor. A matching program is then inputted into the computer processor to repeatedly sort by building address a working database of the insurance status of each tenant. To insure the accuracy of the data base, a statistical sampling and verification of the data provided is periodically performed.

The computer processor then generates a real time series of reports to the building owner, business manager, and various insurance carriers listing all of the insured and uninsured tenants of an apartment complex or multi-unit dwelling. Expired tenant insurance lists may also be sent to these parties.

The insurance carrier generally pre-qualifies the apartment complex or multi-unit dwelling for renter's single interest insurance, or tenant occupancy insurance via an actuarial assessment computer program inputted into the computer processor that establish the premiums required for each building. This qualification is generally conditioned on periodic updates of the data base being provided by the building owner or manager that the occupancy and types of tenants do not materially fall to unacceptable levels. Once the building is pre-qualified, a tenant will have renter's single interest insurance when he rents an apartment or dwelling unit. This renter's single interest insurance will provide coverage to protect the landlord from unintentional acts of his tenants. RSI coverage is limited to the perils of fire, smoke, explosion and water damage, as well as liability incurred by the tenant so that the coverage can be automatically pre-approved and extended without any independent review triggered by additional risk factors involved in coverages, such as bodily injury. Typically, RSI this insurance is capped at the value of the apartment unit, or a pre-set limit. For example, replacement cost as opposed to Actual Cash Value representing depreciated value of the building in the event of loss could be specified to cover the real property to avoid a financial burden on the building owner in the event of loss. Replacement cost would still be specified for the tenants to eliminate any financial incentives for the tenants to start a fire to replace worn out personal property.

RSI insurance also includes the good tenant coverage, which provides coverage to tenant property damage caused by the landlord or negligent tenant. Good tenant coverage will be categorized on a per unit limit per occurrence basis. Coverage of a pre-set limit, such as a $1,000.00, could be included for displaced residents having to relocate because of unintentionally caused damage. Additional income disability coverage could also be added and included in the payment of the tenant's lease payments in the event of disability.

Alternatively, the tenant may elect to participate in tenant occupancy insurance provided through the building owner. This allows the tenant to purchase insurance through a rent surcharge to cover tenant liability and personal property. The amounts of coverage for the building units are pre-approved by the insurance carrier and listed on internet screens. The tenant then simply checks the coverage desired, and the bill is added to the monthly rent charge.

Premiums are then periodically generated and billed to the building owner and tenant based on tenant occupancy and preferences at the end of each payment period. This allows the building owner the option to pay for insurance as the leases are renewed, rather than paid in advance. The method does not contemplate any earned premium at the inception for the reason that RSI insurance is mandatory and not optional unless the resident can prove similar insurance coverage is already in place. Based on the computer generated apartment complex or multi-unit dwelling occupancy insurance reports and updates, the building owner or manager can minimize the exposure from accidental tenant damage and provide another source of recovery in the event of loss.

### Apparatus

To perform the method, the apparatus comprises a computer processor associated with a memory storage system. Inputted into the memory storage system are building physical information, tenant occupancy information, tenant rental information, and a heuristic computer matching program. Before sorting, the computer then expands the data base by common categories to provide corresponding insurance data for every tenant occupying a building or apartment. The data base is further sorted and matched in accordance with an insurance rating system for submittal to interested insurance carriers for rate quotations and approval qualification. An actuarial qualification program is then inputted into the computer to screen and qualify each multi-unit dwelling for tenant occupancy insurance, and establish the premium rates. After qualification, an interactive printer or display monitor controlled by the computer processor then prints or displays the identity of qualified multi-unit dwellings or apartments, and the insurance rates and coverage available for renter's single interest or tenant occupancy insurance. Information as to additional riders for additional insurance coverage may also be included. These interactive insurance screens may also include insurance questionnaires making inquiry as to a tenant's other insurance needs, such as automobile insurance.

The building physical information, tenant occupancy information, and tenant rental information data base is preferably entered into the computer on-line via internet screens, but discs, magnetic tape strips, etc may also be employed. After the generation of the tenant data base, random sampling and follow-ups may be conducted by the insurance carrier or building owner or manager to verify the accuracy of the data base. If significant errors are detected, appropriate adjustments to the data entry gathering and procedures are made, or the insurance cancelled. Thus the method provides a novel tenant insurance coverage for both the tenant and owner in a pre-qualified geographical region.

The above method and apparatus thus provides a simple means for meeting the needs of both the tenant and building owner with insurance unique as to the time coverage begins and ends. It also generates insurance leads as to additional insurance through non-insurance personnel who are not paid a commission or salary. More importantly, it makes available a new insurance product covering both the landlord and tenant based on continual computer monitoring of the tenant insurance status of a multi-unit dwelling complex.

The method and apparatus also provides a social benefit to the community in that an insurance remedy is offered instead of having to rely on community charitable resources, such as the Red Cross, when a large apartment fire occurs, keeping in mind that approximately 90% of the renter's in the United States are currently uninsured.

### DESCRIPTION OF THE DRAWINGS

FIG. 1 illustrates a schematic flow diagram of a preferred method and apparatus.

FIG. 2 illustrates a sample Renter's Single Interest and Tenant Occupancy Computer Screen.

FIG. 3 illustrates schematic flow diagram of a preferred configuration of the apparatus.

FIG. 4 illustrates an example of a router connection to a global information network.

FIGS. 5 through 9 illustrate a series of flow sheets of a preferred method for purchasing and issuing ROI and TOI insurance when using a global information network.

FIG. 10 illustrates a preferred log in computer screen.

FIG. 11 illustrates a preferred Administration Area computer screen.

FIG. 12 illustrates a preferred User List computer screen.

FIG. 13 illustrates a preferred Add User Administration computer screen.

FIG. 14 illustrates a preferred Apartment List computer screen.

### DESCRIPTION OF THE ILLUSTRATED EMBODIMENTS

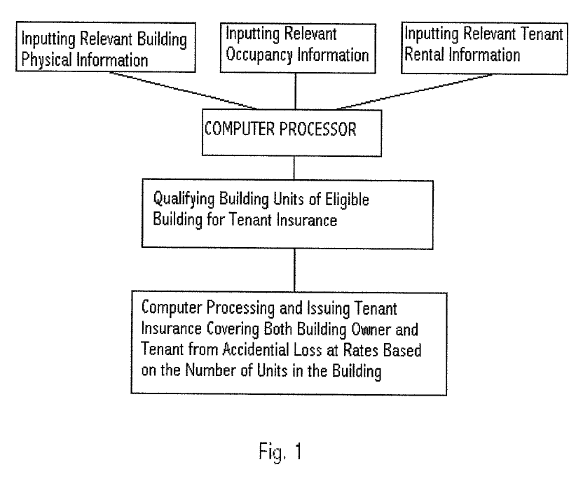

FIG. 1 illustrates a schematic flow diagram of the basic preferred overall method. The first phase of the method comprises first inputting into a computer data base relevant building physical information, occupancy information, and tenant rental information. This information is then expanded and tested by the computer employing a matching program to insure that there is one record per unit. Thus every unit is matched with a tenant, and any renter's insurance policy. Reports of incomplete data are then sent to the building owner or manager, or insurance carrier to update and correct their files. An insurance qualification program is then inputted into the computer processor to qualify the property for tenant insurance, and establish the periodic premiums for payment by the tenant. The computer then translates and matches the tenants with their insurance policies to generate the tenant lists as a working data base.

From the uninsured tenant lists, the building owner or manager can take appropriate steps to enforce the lease provisions requiring tenant insurance coverage. In addition, the working data base is monthly audited and statistically sampled to insure its reliability. Generally, this process produces monthly internal audit reports and provides additional insurance leads to those tenants desiring additional insurance.

The second phase of the method allows the uninsured tenants to purchase directly on-line tenant occupancy insurance. The data base is then updated and a bill prepared based on the total number of units in the building qualified for insurance and sent by the computer to the landlord for inclusion in the monthly rent charges for the insurance additional coverage.

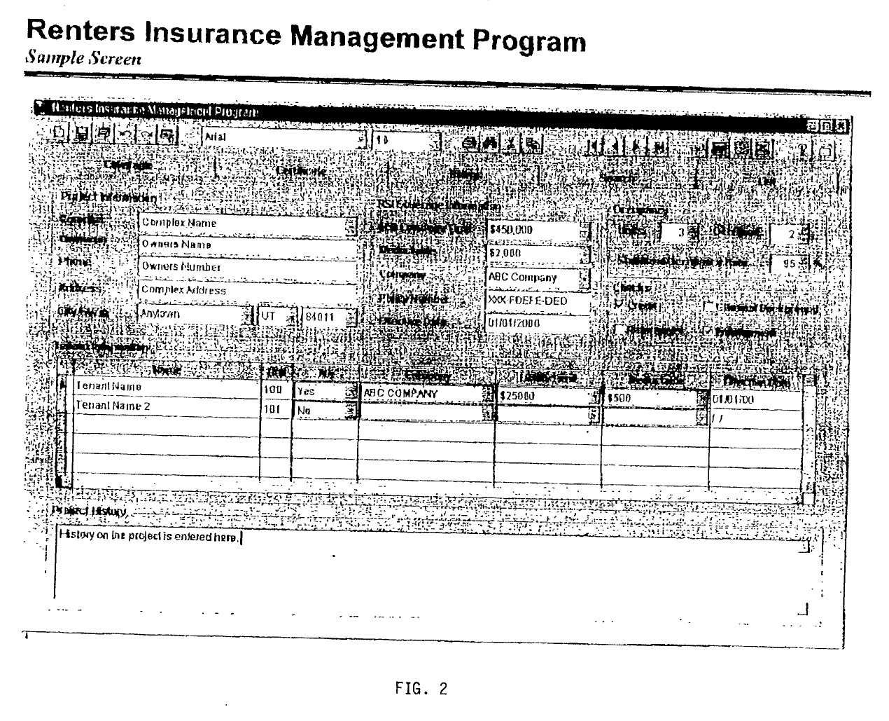

FIG. 2 illustrates an example of a combination Renter's Single Interest and Tenant Occupancy Insurance Screen to computer gather information for issuing insurance. The Screen has draw down interactive sub-screens for listing all of the tenants in the apartment complex, the tenants that have purchased insurance through the apartment complex over the basic renter's single interest coverage, the tenants that have provided their own insurance through other means, and those units not currently occupied. Generally, these interactive screens gather the relevant building physical information, such as the full name of the insured, the mailing addresses of the building units, the number of buildings, the fire insurance policy on the building and rating by the four basic types of construction recognized in fire insurance coverage. They may also gather the date the building was constructed, the protection class, number of fire hydrants, prior loss information as to liability and property claims, and any updating of the buildings, such as the installation of circuit breakers, wiring, roof replacement, plumbing up-grades, and heating and air conditioning replacement. In addition, the number of buildings in the complex, the units per building, and the units currently occupied in each building, may be in-putted.

The relevant occupancy information generally includes the total number of units occupied, and the total number of units vacant at the last reporting period. It may also include the building tenant's age, date of birth, marital status, type and length of employment, credit and criminal background checks, previous residence location, and prior losses. This information is then electronically transmitted to a large insurance data base on a global information network.

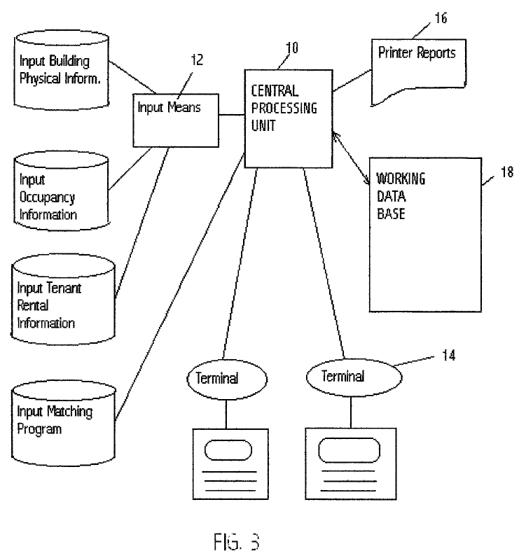

FIG. 3 illustrates schematic flow diagram of a simple configuration of the apparatus used to compute, translate and generate the working data base for use and review by the building owner or manager. A computer processor, such as a personal computer 10, is operationally associated and connected to input means 12, such as a disc reader or keyboard (not shown), a display terminal 14, and a printer 16. The system apparatus is loaded with various data bases including building physical information, occupancy information, and tenant rental information, and a sorting and matching program, which matches, and periodically tests the data before generating the tenant data base.

The personal computer 10 then activates the computer terminal display 14 to display the insurance status for a given tenant for review. The personal computer 10 may then activate a printer 16 to print a list of uninsured tenants, or causes the information to be electronically transmitted to a building owner or manager. The personal computer 10 also generates a working data base and transmits it to a database server 18, such as that described below.

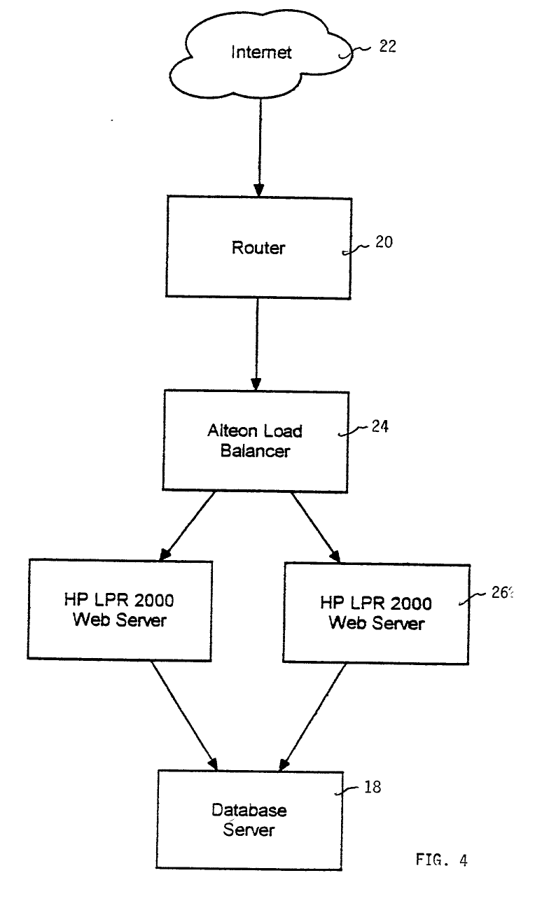

FIG. 4 illustrates an example of a router 20 and connections to the global information network (internet) 22 provided by the hosting facility to provide insurance on-line. An Alteon Switch 24 is used to do Smart Load Balancing to give support for web site load balancing as well as redundancy control. The Alteon Switch 24 is thus associated with two Hewlett Packard (HP) model LPR 2000 web servers 26 which run the Apache Web Server with PHP embedded on top of a Red Hat Linux operating system. Each LPR 2000 web server 26 will have an internal and external NIC card (not shown). The external NIC cards will access the internet 22, and the internal NIC cards will access the database of a database server 18. This structure gives added security to only allow web servers access to the database. No external devices will therefore be able to access the database. The database server 18 will be running PostgreSQL as the database on top of the Red Hat Linux operating system.

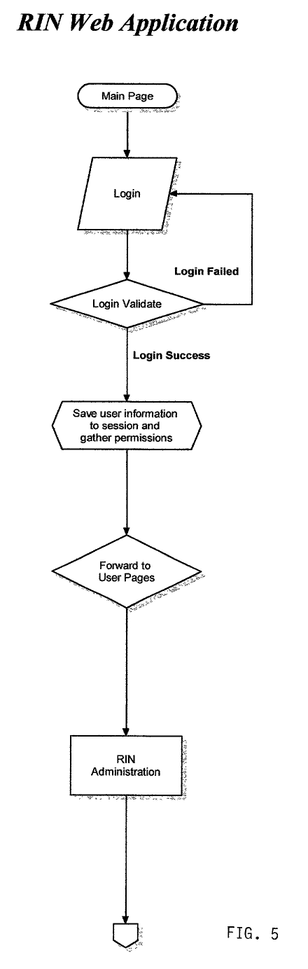

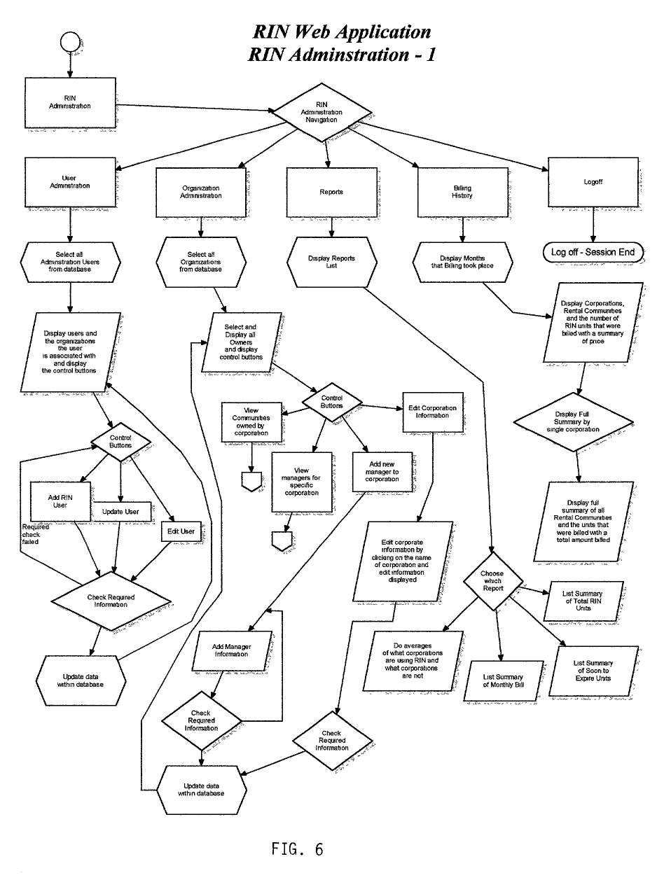

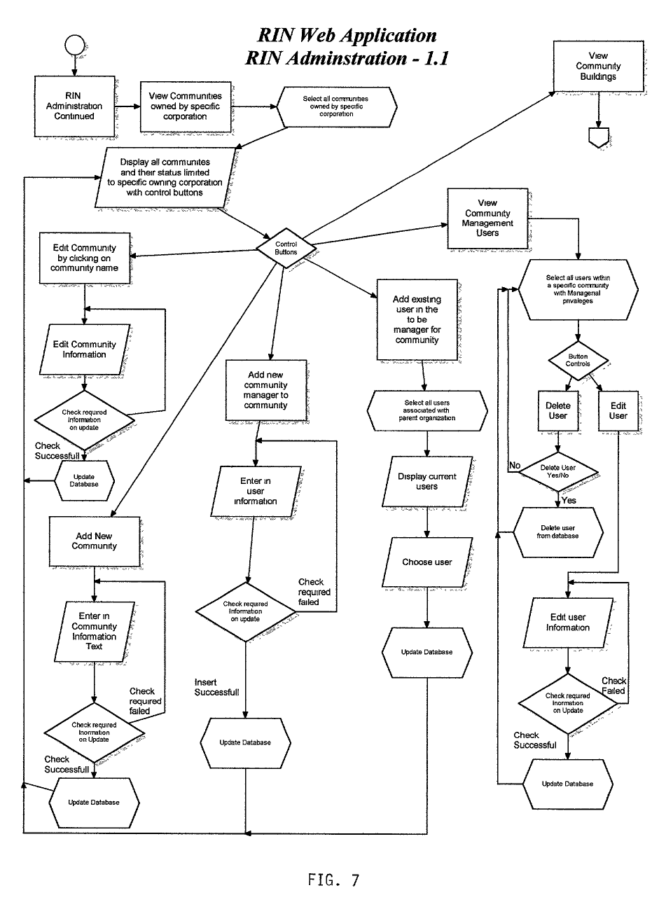

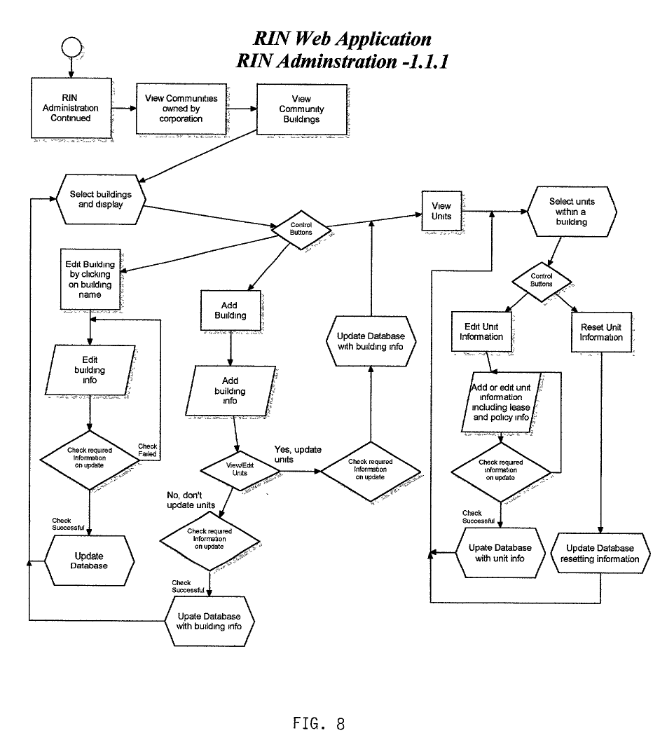

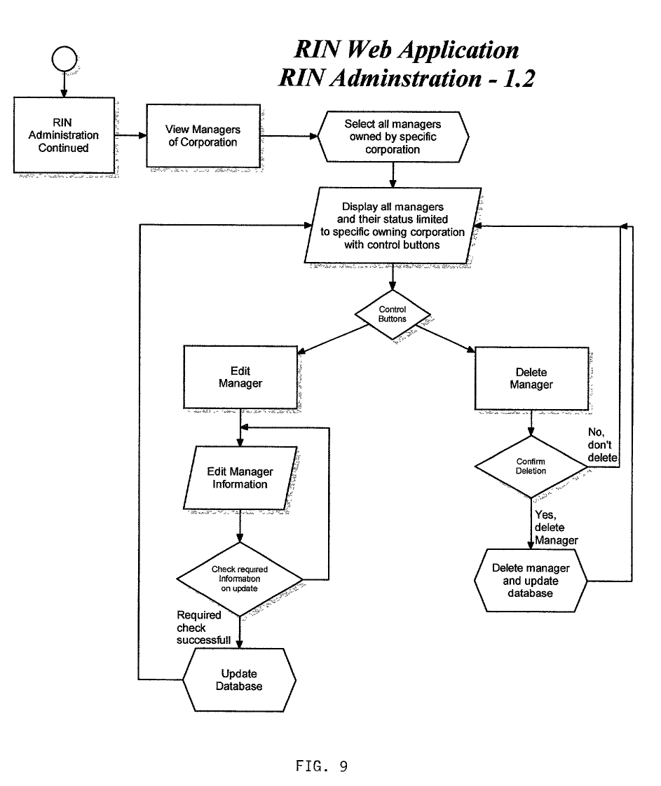

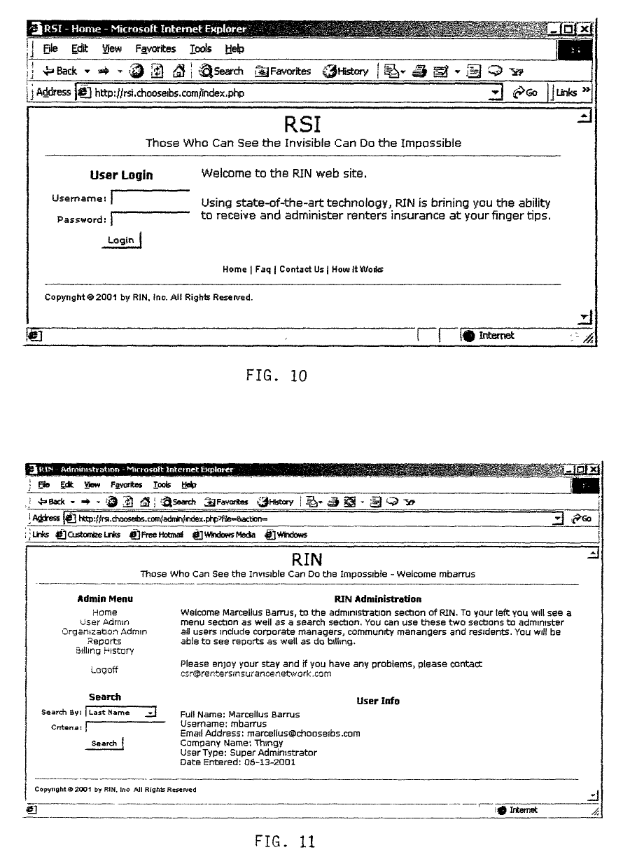

FIGS. 5 through 9 are a series of flow sheets illustrating an example of a preferred method for purchasing and issuing ROI and TOI insurance employing a copyrighted software program entitled “Residents Insurance Network” produced by Integrated Business Solutions of Salt Lake City, Utah for use with a global information network 12. To enter the Residents Insurance Network (RIN) website, the internet user will log in and be forwarded to a main page information with the ability to click on links that go to the Frequently Asked Questions page, the Contact Us page, and the How It Works page. Also on the main page will be a universal login to allow secure access to administration pages. The web site will be laid out in a very simple format to allow easy maintenance and fast download times with the ability to customize the look and feel. See FIG. 10 for an example.

Once a user enters the main website and logs in through the universal login, the user is connected to his/her administration depending on the permissions preset for the user. If a user is an administrator, he will be forwarded to the administrator section. If the user is a corporate manager, he will be forwarded over to the corporate manager section, etc.

Super Administration

The Super Administration area is where the administrators of RIN will go to administer all users within the RIN network. Currently, there are two portlets available. One is a user search and the other is the administration menu. See FIG. 11 for an example.

Searching for a user can be accomplished in five different ways. Using a pull down menu, the user can search by username, first name, last name, email address, or user identification. The user identification number is assigned automatically upon signup. Within the super administration area, the search portlet will search for all users whether they are administration, corporate, community managers or resident. Data will be display in alphabetical order depending on the last name of the users that match the criteria set in the search. The resulting page is displayed within the user administration except if the information was narrowed down by a search criterion.

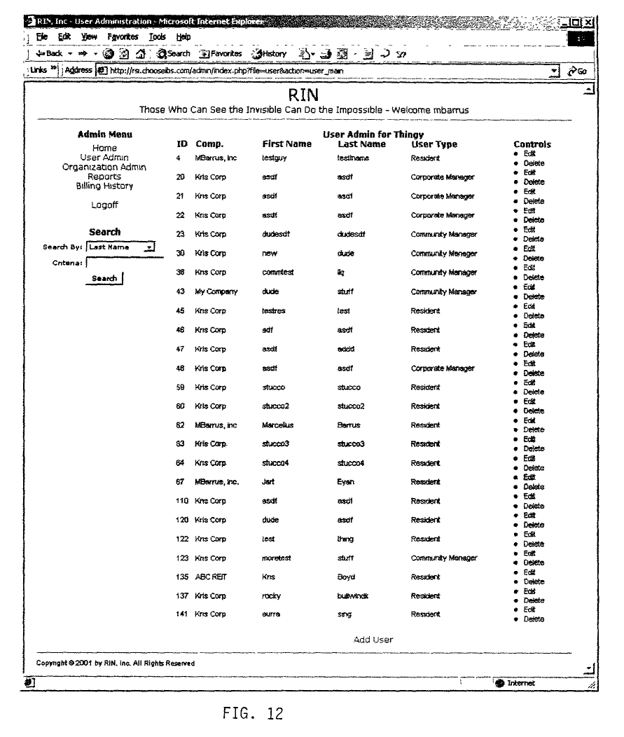

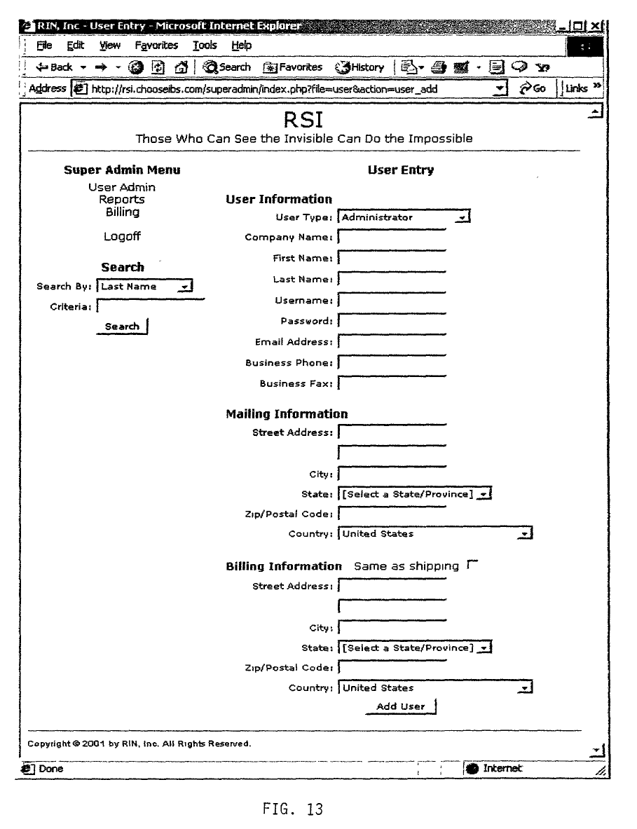

When clicking on the ‘User Admin’ link within the menu portlet, the user will see a screen that lists all users alphabetically, with the option of sorting the list by company name, first name, last name, or user type. At the bottom of every screen within the user administration, as shown in FIG. 12, the user has the option of adding new users no matter what their type. Also on this screen, the user will have the ability to edit or delete the specified user. If a user is a corporate or community manager, the administrator will be able to drill down to their level and administer information specific to their communities. Notice that the menu portlet and the search portlet remain intact to allow for easy navigation through the super administration section.

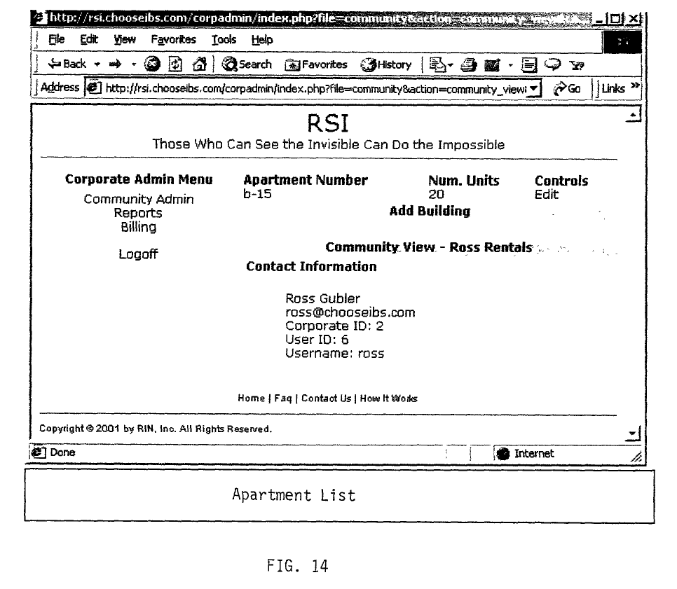

Adding a user is very straight forward, required information is: the user type, first name, last name, username, password, email address, company name, business phone number, business fax and shipping and mailing addresses as seen in FIG. 13. Once this information is entered and the submit button is pressed, the user is added to the database. If the user permissions have been set on initial signup, the user immediately has access to this site and can immediately start administrating communities or residents.

Reports are accomplished by clicking on the ‘Reports’ link within the menu portlet. This allows the super administrator to determine how many users are set up and active. This will drill down to the level of community information and residents. The super administrator will be able to see what communities that are signed up and how many residents they have active within the system. Specific reporting can be created relatively easy as long as RIN is storing the data within the database. Billing information can also be reported.

Every month, billing can be done. No billing is done within the RUN network web site except the ability to gather information and send it over to the RIN billing department. This information will be a flat file that is dumped once a month for transmission. This process can be done automatically depending on abilities of the billing department.

On the tenth of every month, a mock billing will be done. This mock billing will be sent out to all corporate managers and rental community managers to look over their bill and fix any discrepancies within the Residents Insurance Network system. Manager will have the ability to add new residents to the billing process or clean units up so that they are not billed. When an individual is entered in the first time, the monthly bill is prorated and will be billed the following month. So, the first time an individual will be billed will take place the second month of activity with a partial bill for the partial month of activity plus the current months bill. There are three applications that run on the server machine that run as scheduled programs once a month. The first has been code named ‘Billing History Mock’. This application runs the billing history that allows individuals to make the changes that need before the billing actually takes place. The second application has been code named ‘Billing History’. This application runs the billing history. That data that we receive from this application is live data for billing reports as well as what information is sent to the billing department. The third application has been code named ‘Billing Batch’. The ‘Billing Batch’ application pulls all the appropriate billing information for that month from the database that the ‘Billing History’ application stored. Once this information is gathered, it is sent over the billing department as a flat text file delineated by a ‘˜’.

Corporate and Community Administration

The ‘Corporate Administration’ and the ‘Community Administration’ is very similar to the ‘Super Administration’ except that the corporate administrator only has access to his specific information. Depending on the permissions that have been set by the super administrator, the corporate administrator can add communities, search users, view billing information (not do billing), and view and modify residents if required. Searching capabilities will also be given to the corporate administrator but will be limited only to users that have been granted access by the super administrator.

The community manager has the ability to add buildings to his community and residents to those buildings. FIG. 14 comes from the corporate administration section depicting the capability to accomplish all required functions within the community. NOTE: A community manager shown as Ross Gubler cannot do everything that a corporate manager can do. FIG. 14 also shows that Ross Rentals' community manager is Ross Gubler and it has one building registered to date with 20 units. Ross Gubler has the ability to go in and update rental information and assign residents to those units. With that registration, Ross Gubler has the ability to add each resident to the RIN network. Thus, allowing each resident to have insurance.

Resident Registration

Registration of a resident is very similar to when a super administrator adds a user and is a subset of that function. Additional information will be added to the resident information explaining when leases are due. This information will be used for reporting and billing information and will be accessible only to the super administrator, the corporate administrator and the community manager. Once a resident has been registered with RIN, a printed certificate will given to the resident stating that insurance has been obtained through RIN. This certificate will be programmed with XML and will be printer friendly to be printed at the time of lease signing. The super administrator, corporate administrator, community manager or the resident himself can pull up the certificate at any time. Also, at the conclusion of registration, the resident can confidently state that renters insurance has been purchased.

After a resident has been registered as a RIN user, he now has access to the ‘Residents Only’ area. Within this area, the resident can access a sample policy, view the question and answers for policy holders, and view and print his policy certificate. The resident can also view personal lease status and expiration.

Web Site Software

Residents Insurance Network is a fully functional site monitored by Integrated Business Solutions (IBS) of Salt Lake City, Utah to allow RIN the ability to easily administer rental insurance for corporations and community managers. IBS has selected the Red Hat Linux 7.1 software to power the web site and the backend applications. The Apache Web Server serves web pages for the RIN web site. Apache is a multi-platform web server that is easily extendable to allow rapid customization to fit a specific profile of an individual company.

PHP is the programming language. Because of the extendibility of the Apache Web Server, PHP can be compiled into it as a module to work as one. This allows a web site using the PHP technology to run more smoothly and efficiently.

PostgreSQL is the backend database server. PostgreSQL is an open source database server that competes commercially with Oracle. It has the capability to process millions of records without degradation. It complies with most of the SQL92 and SQL99 specification providing an easy migration to an Oracle database if required.

Web Site Hardware

HP servers are examples of preferred web site hardware. To accommodate growth and web site reliability, the web site hardware may be partitioned into phases as business expands. Initially, IBS has only documented phase one hardware and will define phase two and three as appropriate. The present preferred hardware comprises:

HP LP 2000r

2-36 Gig Hardrive

1-Raid Scsii Controller (NetRaid 4)

2-10/100 Base T NIC

1-Gig Memory

1-Video Card

1-CD-ROM

1-DDS3

2-933 mhz Processors

2-Power Supplies

Rack Mounted

Linux OS

Web Site Hosting

Web hosting is facilitated by VIA West in Salt Lake City. VIA West specializes in delivering quality broadband access, shared and dedicated server-hosting, collocation and managed services consulting to small and medium-sized businesses.

The configuration of the method and apparatus is adjusted to provide the informational data and reports required to enforce and administer building insurance lease requirements. In addition, the apparatus may employ a heuristic program to insure the high degree of accuracy and statistically reliability of the uninsured tenant lists.

Although the foregoing specification refers to the illustrated embodiments, it is not intended to restrict the scope of the appended claims. The claims themselves recite those features deemed essential to the invention.

I claim:

1. A method for insuring an apartment or multi-unit dwelling unit comprising:
a. inputting into a computer processor a data base of sufficient building physical information and the number of units in the apartment complex or multi-unit dwelling complex to qualify the complex for fire insurance coverage,
b. inputting into a computer processor sufficient tenant data to qualify the complex for single renter insurance coverage,
c. computer qualifying the apartment or multi-unit dwelling via an algorithm processing the building physical information and the tenant data for tenant insurance covering the building owner from unintentional damage caused by the tenant from fire, smoke, explosions, water damage, or negligence injuries by the tenant caused to third parties pursuant to predetermined insurability criteria,
d. computer generating a base rate charge for the tenant insurance based on the building physical information and number of units in the complex,
e. issuing tenant insurance covering the complex, and
f. billing the owner for the tenant insurance coverage.

2. A method for insuring an apartment or multi-unit dwelling unit according to claim 1, wherein the relevant building physical information comprises the full name of the insured, the mailing addresses of the building units, the number of buildings and units, the fire insurance policy on the building and rating by the four basic types of construction recognized in fire insurance coverage.

3. A method for insuring an apartment or multi-unit dwelling unit according to claim 1, wherein the relevant occupancy information comprises the total number of units occupied, and the total number of units vacant at the last reporting period.

4. A method for insuring an apartment or multi-unit dwelling unit according to claim 3, wherein the relevant occupancy information includes tenant rental information, such as lease agreement requirements, the limits of coverage, a credit report on the tenant coded to meet legal confidentiality requirements, a criminal background check of the tenant, and a character reference check of the tenant to verify his past tenant conduct.

5. A method for insuring an apartment or multi-unit dwelling unit according to claim 1, wherein the relevant building physical information, occupancy information, and tenant rental information is inputted monthly.

6. A method for insuring an apartment or multi-unit dwelling according to claim 1, wherein the tenant insurance covers both the owner and the tenant and the tenant's personal property within the unit.

7. A method for insuring an apartment or multi-unit dwelling unit according to claim 6, including providing on-line real time computer display access to tenants to purchase either renters single interest or tenant occupancy insurance.

8. A method for insuring an apartment or multi-unit dwelling unit according to claim 1, including mailing notices requesting insurance verification to uninsured tenants and inputting and updating the working data base with the uninsured tenants' replies to the notices.

9. A method for insuring an apartment or multi-unit dwelling unit according to claim 1, including computer generating and transmitting trend report summaries of the status of uninsured tenants to authorized parties.

10. A method for insuring an apartment or multi-unit dwelling unit according to claim 8, wherein the report summaries are coded and masked for confidential access.

11. A method for insuring an apartment or multi-unit dwelling unit according to claim 1, including providing computer on-line access to a tenant to the insurance data base via interactive computer screens enabling the tenant to select the tenant occupancy insurance limits of coverage, and computer generating a bill for the insurance based on the number of units in the building and the limits of coverage, which is provided along with a tenant's monthly rental statement.

12. A method for insuring an apartment or multi-unit dwelling unit comprising:
a. inputting into a computer processor a data base of relevant building physical information about the apartment complex or multi-unit dwelling complex such as the full name of the insured, the mailing addresses of the building units, the number of buildings and units, the fire insurance policy on the building and rating by the four basic types of construction recognized in fire insurance coverage
b. inputting into a computer relevant occupancy information about the apartment or multi-unit dwelling complex, such as the total number of units occupied, and the total number of units vacant at the last reporting period.
c. inputting into a computer relevant tenant rental information, such as lease agreement requirements, the limits of coverage, a credit report on the tenant coded to meet legal confidentiality requirements, a criminal background check of the tenant, and a character reference check of the tenant to verify his past tenant conduct,
g. computer qualifying the apartment or multi-unit dwelling unit via an algorithm processing the building physical information and the tenant data for tenant insurance covering both the building owner from unintentional damage caused by the tenant from fire, smoke, explosions, water damage, or negligence injuries by the tenant caused to third parties pursuant to predetermined insurability criteria,
h. computer generating a base rate charge for the tenant insurance based on the building physical information and number of units in the complex, and the limits of coverage, issuing tenant insurance covering the complex, and billing the owner for the tenant insurance coverage.

13. A method for insuring an apartment or multi-unit dwelling according to claim 12, wherein the tenant insurance provides a pre-set amount of coverage for displaced residents, and an additional sum for living expenses to the resident unintentionally causing damage to the dwelling unit.

14. A method for insuring an apartment or multi-unit dwelling according to claim 12, wherein the tenant insurance covers the owner's property for replacement cost.

15. A method for insuring an apartment or multi-unit dwelling according to claim 12, wherein the tenant insurance includes disability insurance, which pays the lease payment in the event an insured resident is disabled.

16. A method for insuring an apartment or multi-unit dwelling according to claim 15, wherein the tenant insurance includes disability insurance also provides income benefits to the disabled resident.

17. A method for insuring an apartment or multi-unit dwelling according to claim 12, wherein the tenant insurance includes an accidental death benefit payable to a beneficiary in the event of death of the resident.

18. A method for insuring an apartment or multi-unit dwelling according to claim 12, wherein the owner is billed for insurance to be paid on lease renewal or generation.

19. A method for insuring an apartment or multi-unit dwelling according to claim 12, including requiring residents who have opted to independently purchase insurance to issue an insurance certificate naming the property owner as an additional insured and/or certificate holder of record, and inputting property owner's notice of residents'insurance cancellation into the computer and monitoring the unit insurance coverage via computer.

20. A method for insuring an apartment or multi-unit dwelling according to claim 19, wherein the residents' insurance cancellation is monitored from a remote monitor interconnected to the computer.

21. A method for insuring an apartment or multi-unit dwelling according to claim 19, wherein residents allowing their insurance to lapse are automatically insured for resident single interest insurance and computer billed therefore.

22. A method for insuring an apartment or multi-unit dwelling according to claim 12 wherein the provider of the building insurance provides credits against policies covering the property owner who has 100% of the residents' units insured.

23. A method for insuring an apartment or multi-unit dwelling according to claim 22, wherein RSI certificates are issued to those insurance companies offering credits against policies.

24. A method for insuring an apartment or multi-unit dwelling according to claim 23, including computer linking the web site of those companies receiving RSI certificates with the computer.

25. A method for insuring an apartment or multi-unit dwelling according to claim 12, wherein the tenant insurance includes traditional HO-4 form policy coverage.

26. A method for insuring an apartment or multi-unit dwelling according to claim 25, including computer linking the web site of those companies providing HO-4 form policy coverage with the computer.

27. A method for insuring an apartment or multi-unit dwelling according to claim 26, including allowing insurance companies offering traditional HO-4 form policies to advertise on the computer network.

28. A method for insuring an apartment or multi-unit dwelling according to claim 26, wherein the computer billing includes the fee for providing tradition HO-4 form policies.

29. A method for insuring an apartment or multi-unit dwelling according to claim 12, wherein the computer billing also includes a fee for management.

30. An apparatus for insuring an apartment or multi-unit dwelling unit comprising:
a. input means,
b. storage means into which a data base of
i. sufficient building physical information about the apartment complex or multi-unit dwelling complex and number of units to qualify the complex for fire insurance coverage,
ii. sufficient tenant data to qualify the complex for renter's single interest insurance coverage,
iii. a sorting and matching program to computer process the data bases by heuristic matching of non-corresponding sequences to generate a working data base of uninsured tenants and units to a pre-determined high degree of reliability,
c. a computer processor to:
i. qualify the apartment or multi-unit dwelling unit for tenant occupancy insurance to protect the landowner from unintentional damage caused by fire, smoke, explosions, water damage, or negligence injuries caused by the tenant, and to calculate the insurance rates based on tenant occupancy,
ii. generate a base rate charge for the tenant insurance based on the building physical information and number of units in the complex, and
iii. issue tenant insurance covering the unit, and billing the owner for the tenant insurance coverage; and
d. an interactive display terminal operably associated with and activated by the computer processor unit to display insurance rates and allow interested parties to purchase tenant occupancy insurance.

31. An apparatus for insuring an apartment or multi-unit dwelling unit according to claim 30, wherein the data base includes:
i. relevant building physical information about the apartment complex or multi-unit dwelling complex such as the full name of the insured, the mailing addresses of the building units, the number of buildings and units, the fire insurance policy on the building and rating by the four basic types of construction recognized in fire insurance coverage
ii. relevant occupancy information about the apartment or multi-unit dwelling complex, such as the total number of units occupied, and the total number of units vacant at the last reporting period.
iii. relevant tenant rental information, such as lease agreement requirements, a credit report on the tenant coded to meet legal confidentiality requirements, a criminal background check of the tenant, and a character reference check of the tenant to verify his past tenant conduct,

32. An apparatus for insuring an apartment or multi-unit dwelling unit according to claim 30, including electronic signal transfer means to transmit coded electronic signals to a receiving translator, which converts the coded electronic signals into printed reports for authorized building owners, managers, or insurance carriers.

33. A landlord renter's single interest insurance policy according to the method of claim 1.

34. A tenant insurance policy according to claim 33, wherein the renter's single interest insurance policy allows additional tenant occupancy insurance coverage, which also covers the tenant and the tenant's personal property in addition to damage to the unit.

35. A tenant insurance policy according to claim 34, wherein the tenant occupancy insurance coverage policy allows the tenant to acquire coverage by paying an additional insurance premium as part of the unit rent.
